(19) United States
(12) Patent Application Publication
(10) Pub. No.: US 2025/0350594 A1
(43) Pub. Date: Nov. 13, 2025

(54) BRAINWAVE ELECTROMAGNETIC FIELD FLUCTUATION-BASED AUTHENTICATION

(71) Applicant: Microchip Technology Incorporated, Chandler, AZ (US)

(72) Inventor: Valentin Stoia, Bucharest (RO)

(73) Assignee: Microchip Technology Incorporated, Chandler, AZ (US)

(21) Appl. No.: 18/742,070

(22) Filed: Jun. 13, 2024

Related U.S. Application Data
(60) Provisional application No. 63/643,708, filed on May 7, 2024.

(51) Int. Cl. H04L 9/40

(52) U.S. Cl. CPC H04L 63/0861

(57) ABSTRACT

Systems and methods for brainwave electromagnetic field fluctuation-based authentication are provided. A system may include an authentication circuit. The authentication circuit may be to observe a stimulation provided to a user. The authentication circuit may be also to receive a brainwave electromagnetic field fluctuation of the user in response to the stimulation. The authentication circuit may be further to compare the brainwave electromagnetic field fluctuation to a predicted response. The authentication circuit may be further to authenticate the user based on the comparison.

### PRIORITY

This application claims priority to U.S. Provisional Patent Application No. 63/643,708, filed May 7, 2024, the contents of which are hereby incorporated in their entirety.

### TECHNICAL FIELD

The present disclosure relates to user authentication, and more specifically, to brainwave electromagnetic field fluctuation-based authentication.

### BACKGROUND

Large, generative artificial intelligence (AI) models (e.g., Chat GPT, Google Gemini) have begun to influence trends in embedded products across a variety of industries. Using AI models, users may wish to interact with a personal AI assistant. Personal AI assistants may be customized for a user's personality, habits, preferences, and the like. Use of personal AI assistants may lead to security risk concerns. For example, for privacy reasons, a user may choose to run an AI assistant in an offline mode. The user may wish to authenticate and interact with the AI assistant using a secure mechanism to shape the AI assistant's character, share personally sensitive information, and to provide new information to the AI assistant from a personal perspective.

Existing methods for authenticating a user of an AI assistant have limitations. For example, voice and facial recognition may be subject to deep fake replicas, fingerprint authentication may be copied or have accuracy issues, eye scanning authentication may use cumbersome interactions by the user (e.g., camera movement, use of intrusive smart glasses, adjusting for insufficient light conditions), and passwords may be overheard by unauthorized persons.

### SUMMARY OF THE INVENTION

Examples of the present disclosure may include an apparatus. The apparatus may include an authentication circuit. The authentication circuit may be to observe a stimulation provided to a user. The authentication circuit may be also to receive a brainwave electromagnetic field fluctuation of the user in response to the stimulation. The authentication circuit may be further to compare the brainwave electromagnetic field fluctuation to a predicted response. The authentication circuit may be further to authenticate the user based on the comparison.

In combination with any of the above examples, the authentication circuit may be to establish a communications channel with an electrode and instruct the electrode to capture the brainwave electromagnetic field fluctuation of the user.

In combination with any of the above examples, the communications channel may be a body-based communications channel, a wired communications channel, or a wireless communications channel.

In combination with any of the above examples, the authentication circuit may be to receive the brainwave electromagnetic field fluctuation of the user in response to the stimulation from an electrode coupled to the user.

In combination with any of the above examples, the comparison of the brainwave electromagnetic field fluctuation to the predicted response may include a determination of whether the brainwave electromagnetic field fluctuation is within a confidence interval of the predicted response.

In combination with any of the above examples, the authentication circuit may be to prompt the user with a training stimulation and record a response of the user based on the training stimulation.

In combination with any of the above examples, the authentication circuit may be to update the predicted response based on the brainwave electromagnetic field fluctuation of the user.

In combination with any of the above examples, the apparatus may also include a stimulation circuit to provide the stimulation to the user.

Alone or in combination with any of the above examples, examples of the present disclosure may include a method including providing a stimulation to a user. The method may additionally include receiving a brainwave electromagnetic field fluctuation of the user in response to the stimulation. The method may further include comparing the brainwave electromagnetic field fluctuation to a predicted response. The method may still further include authenticating the user based on the comparison.

In combination with any of the above examples, the method may further include establishing a communications channel with an electrode and instructing the electrode to capture the brainwave electromagnetic field fluctuation of the user.

In combination with any of the above examples, the method may further include receiving the brainwave electromagnetic field fluctuation of the user in response to the stimulation from a plurality of electrodes coupled to the user.

In combination with any of the above examples, the comparison of the brainwave electromagnetic field fluctuation to the predicted response may include a determination of whether the brainwave electromagnetic field fluctuation is within a confidence interval of the predicted response.

In combination with any of the above examples, the method may further include prompting the user with a training stimulation and recording a response of the user based on the training stimulation.

In combination with any of the above examples, the method may further include updating the predicted response based on the brainwave electromagnetic field fluctuation of the user.

Alone or in combination with any of the above examples, examples of the present disclosure may include a system including an electrode to capture a brainwave electromagnetic field fluctuation of a user. The system may additionally include an artificial intelligence (AI) assistant communication interface coupled to the electrode to provide a stimulation to the user. The system may further include an AI assistant coupled to the electrode and the AI assistant communication interface. The AI assistant may be to receive the brainwave electromagnetic field fluctuation of the user in response to the stimulation. The AI assistant may additionally be to compare the brainwave electromagnetic field fluctuation to a predicted response. The AI assistant may further be to authenticate the user based on the comparison.

In combination with any of the above examples, the AI assistant may further be to establish a communications channel with the electrode and instruct the electrode to capture the brainwave electromagnetic field fluctuation of the user.

In combination with any of the above examples, the AI assistant may further be to receive the brainwave electromagnetic field fluctuation of the user in response to the stimulation from a plurality of electrodes coupled to the user.

In combination with any of the above examples, comparison of the brainwave electromagnetic field fluctuation to the predicted response may include a determination of whether the brainwave electromagnetic field fluctuation is within a confidence interval of the predicted response.

In combination with any of the above examples, the AI assistant may further be to prompt the user with a training stimulation and record a response of the user based on the training stimulation.

In combination with any of the above examples, the AI assistant may further be to update the predicted response based on the brainwave electromagnetic field fluctuation of the user.

### BRIEF DESCRIPTION OF THE DRAWINGS

The figures illustrate examples of systems and methods.

FIG. 1 illustrates a system for brainwave electromagnetic field fluctuation-based authentication, according to examples of the present disclosure;

FIG. 2 illustrates a method for brainwave electromagnetic field fluctuation-based authentication, according to examples of the present disclosure; and

FIG. 3 illustrates a more detailed method for brainwave electromagnetic field fluctuation-based authentication, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods for brainwave electromagnetic field fluctuation-based authentication are provided. The brainwave electromagnetic field fluctuation-based authentication may be used to unlock an artificial intelligence (AI)-capable electronic device. In particular, the brainwave electromagnetic field fluctuation-based authentication may be used to unlock or establish a secure communication channel with a private, typically offline, personal AI assistant. The brainwave electromagnetic field fluctuation-based authentication may provide a flexible, yet strong, level of user authentication security that is developed and maintained over time, with insignificant user interaction. Users may not have to remember one or more passwords, be concerned about degradation or changes to the user's biometric authentication methods as time passes or in certain environmental conditions, or be concerned with theft or forgery (e.g., of biometrics, passwords, movement or similar patterns, hardware security keys, or online data exposure).

Aspects include features disclosed in U.S. patent application Ser. No. 18/510,714 filed on Nov. 16, 2023, incorporated herein in its entirety for all purposes.

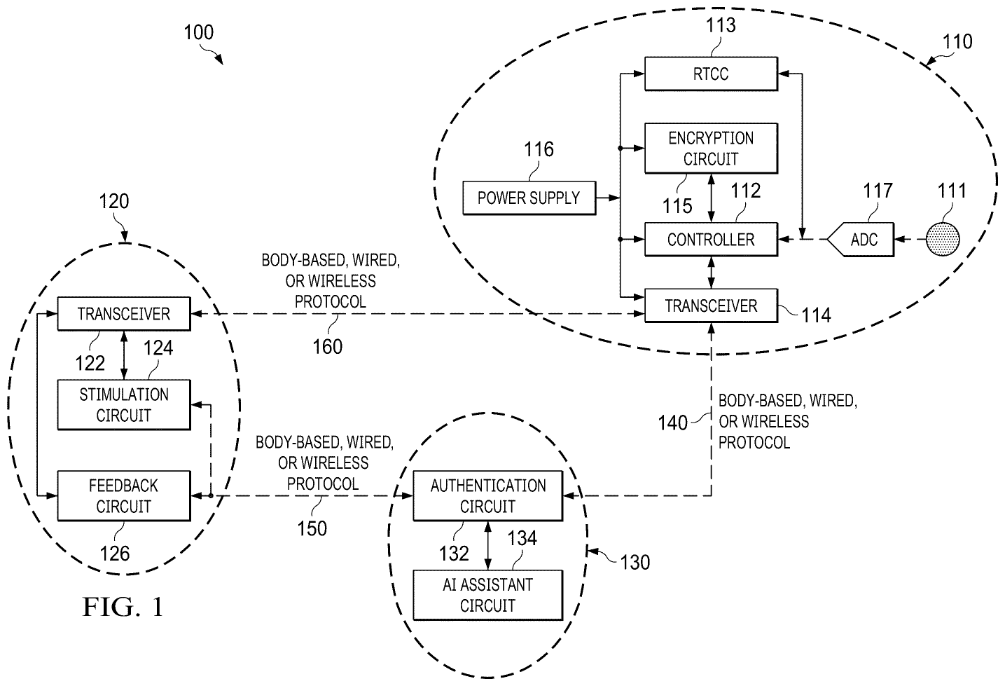

FIG. 1 illustrates a system for brainwave electromagnetic field fluctuation-based authentication, according to examples of the present disclosure. System 100 may include electroencephalogram (EEG) node 110, AI assistant communication interface 120, and AI assistant 130.

EEG node 110 may include one or more electrodes 111. Electrode 111 may be coupled to a user's head to collect information on the user's brainwaves. In examples where EEG node 110 includes more than one electrode 111, the more than one electrodes 111 may form a synchronized network of electrodes. Electrode 111 may be coupled to analog-to-digital converter (ADC) 117 which may convert an analog signal from the one or more electrodes 111 to a digital signal and may transmit the digital signal to controller 112. Controller 112 may process the digital signals for communication to AI assistant communication interface 120 or to AI assistant 130. Controller 112 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein.

EEG node 110 may also include real-time clock/calendar (RTCC) 113. RTCC 113 may maintain accurate time, even when system 100 is powered off. RTCC 113 may be used to time stamp events detected by the electrodes or recorded and processed by AI assistant 130.

EEG node 110 may include transceiver 114 to send and receive information between controller 112, AI assistant communication interface 120, AI assistant 130, or any combination thereof. Transceiver 114 may communicate with AI assistant 130 via communications channel 140 using any suitable communication protocol, such as a body-based communications channel, wired communications channel, or wireless communications channel, including, but not limited to, BODYCOM™, radio frequency (RF) (e.g., Bluetooth), audio waves, infrared, or wired (e.g., universal serial bus (USB), Ethernet) transmission techniques. BODYCOM™ technology is more fully described in Microchip Technology Incorporated Application Note AN1391 “Introduction to the BodyCom Technology,” (2011), available at www.microchip.com, and its content in its entirety is hereby incorporated by reference herein for all purposes. BODYCOM™ body communication systems are also disclosed in U.S. Patent Publication 2015/0044969, wherein its content in its entirety is hereby incorporated by reference herein for all purposes.

EEG node 110 may additionally include encryption circuit 115 that may be used for data certification and encryption. For example, encryption circuit 115 may encrypt data from the one or more electrodes 111 prior to transmission by transceiver 114. Encryption circuit 115 may be used when AI assistant 130 may not be trustworthy and a potential mutual authentication may not succeed. For example, encryption circuit 115 may be used to encrypt communications from EEG node to AI assistant communication interface 120, AI assistant 130, or any combination thereof when encryption keys are not already present on both sides of the communications link. This may occur during an initial one-time setup phase, after which mutual authentication may be performed over a previously encrypted communications channel. EEG node 110 may further include power supply 116 which may be coupled to RTCC 113, encryption circuit 115, controller 112, and transceiver 114 to provide power to the components of EEG node 110. Power supply 116 may be a battery, a DC-DC converter, AC-DC converter, or any other suitable power supply.

AI assistant communication interface 120 may include transceiver 122 to send and receive information between EEG node 110, AI assistant communication interface 120, or AI assistant 130, or any combination thereof. Transceiver 122 may communicate using any suitable communication protocol, such as a body-based communications channel, wired communications channel, or wireless communications channel, including, but not limited to, BODYCOM™, radio frequency (RF) (e.g., Bluetooth), audio waves, infrared, or wired (e.g., USB, Ethernet) transmission techniques. AI assistant communication interface 120 may additionally include stimulation circuit 124. Stimulation circuit 124 may be part of a consumer product, such as an earpiece, earbud, speaker, microphone, display, or any other device suitable for providing a stimulation to a user of system 100. In some examples, stimulation circuit 124 may be in the proximity of at least one of the user's ears to allow stimulation circuit 124 to provide sounds to the user. In other examples, stimulation circuit 124 may be in the proximity of at least one of the user's eyes to allow stimulation circuit 124 to display images to the user. Stimulation circuit 124 may interact with a camera, screen, microphone, speaker (e.g., either in car or using bone conduction), or any combination thereof to provide a stimulation to the user. Stimulation circuit 124 may provide output (e.g., sounds, images) to a user from AI assistant 130 to allow AI assistant 130 to communicate to the user. Additionally, AI assistant communication interface 120 may include feedback circuit 126. Feedback circuit 126 may allow a user to communicate with AI assistant 130 by detecting a response or feedback from the user. For example, feedback circuit 126 may include a microphone to receive voice instructions from the user such as a command to begin the authentication process.

AI assistant 130 may be comprised within a consumer product such as a smartphone, tablet, or smart wearable (e.g., watch, bracelet). AI assistant 130 may include authentication circuit 132 to authenticate a user based on electromagnetic field fluctuation data from EEG node 110. AI assistant 130 may further include AI assistant circuit 134 to perform AI assistant tasks. AI assistant circuit 134 may include software or circuitry to store and execute an AI assistant and store related data.

Interpretation of the brain waves detected by the one or more electrodes 111 in EEG node 110 may be performed by controller 112 in EEG node 110 or at AI assistant 130. In some examples, AI assistant communication interface 120 and AI assistant 130 may be combined in a single unit.

To authenticate a user, authentication circuit 132 in AI assistant 130 may establish secure via communications channel 140 with EEG node 110. In some examples, communication channel 140 may be a pre-configured encrypted communication channel using a one-way communication channel from the EEG node 110 to AI assistant 130. A one-way communication channel may be used in examples where an asymmetric encryption configuration has already been provided by an equipment manufacturer.

AI assistant 130 may trigger a user's emotional response by stimulating one or more of a user's senses (e.g., using an audio sound or displaying an image). AI assistant 130 may transmit a signal to AI assistant communication interface 120 via communication channel 150 to cause stimulation circuit 125 to provide a stimulation to the user. In some examples, AI assistant 130 may not generate the stimulation and may instead, or in addition to generating the stimulation, observe the same real-time environmental data as the user (e.g., listen to the same song on the radio). The real-time environmental data may act as the stimulation. AI assistant 130 may wait for EEG input from EEG node 110 after triggering the emotional response (e.g., after stimulating one or more of a user's senses or observing the same real-time environmental data as the user).

AI assistant 130 may instruct EEG node 110 to capture brainwave electromagnetic field fluctuations and send encrypted data reflecting the fluctuations to AI assistant 130. Specifically, electrode 111 of EEG node 110 may capture brainwave electromagnetic field fluctuations. The analog signals from electrode 111 may be converted to digital signals by an ADC and provided to controller 112. Transceiver 114 may transmit the signals to AI assistant 130. In some examples, the data, encrypted by encryption circuit 115, reflecting the fluctuations may be sent using communication channel 140. In other examples, the data reflecting the fluctuations may be sent from EEG node 110 to AI assistant 130 via AI assistant communication interface 120 through communication channel 160 and communication channel 150.

Authentication circuit 132 in AI assistant 130 may receive the encrypted data from EEG node 110, decrypt the data, and compare the data against a machine learning-based prediction of how the user may react to the provided stimulation. If the data matches the predicted reaction, authentication circuit 132 may authenticate the user. If the data does not match the predicted reaction, authentication circuit 132 may deny access to the user. In some examples, authentication circuit 132 may use a confidence interval to determine whether the data matches the predicted reaction using a machine learning confidence percentage interval to make a decision (e.g., whether to authenticate the user) based on a received input (e.g., the captured brainwave electromagnetic field fluctuation in response to the stimulation). For example, if authentication circuit 132 has greater than 80% confidence that the data matches the predicted reaction, authentication circuit 132 may authenticate the user. The confidence interval may be set by the user (e.g., a higher confidence interval may provide greater security than a lower confidence interval).

After a successful authentication, the user may interact with AI assistant circuit 134 in AI assistant 130. For example, the user may teach AI assistant circuit 134, update AI assistant circuit 134, or share sensitive data with AI assistant circuit 134.

In some examples, authentication circuit 132 may apply an ethical filter to the authentication process. For example, authentication circuit 132 may not authenticate a user if the brainwave electromagnetic field fluctuations indicate that the user is exhibiting extreme anger or distress. In such circumstances, the user's logic may be impaired, and authentication circuit 132 may deny the user access to AI assistant circuit 134 and any sensitive data saved in AI assistant circuit 134. Additionally, AI assistant circuit 134 may provide tools to assist the user in coping with anger or distress.

In some examples, authentication circuit 132 may repeat the authentication process multiple times. Repeated authentication may be used in circumstances where the user seeks an increased level of security.

In some examples, the authentication process may be used in conjunction with other authentication methods, such as, but not limited to, a biometric scan, password, wearable security, or a head movement pattern token. For example, AI assistant 130 may be combined with a wearable device including accelerometers that may be used to capture head movements.

Before the authentication process may be used, authentication circuit 132 may be trained to learn the user's reactions to stimulation such that authentication circuit 132 learns the user's response in test cases, for authentication circuit 132 to provide a predicted response. During the training process, authentication circuit 132 may record personal information about the user via audio communication, visual communication, or any combination thereof. Authentication circuit 132 may then prompt the user with questions based on the recorded personal information and begin correlating the information in the prompts with EEG readings (e.g., brainwave electromagnetic field fluctuations). The questions may be presented in any suitable format, such as, but not limited to, audio or visual formats. For example, authentication circuit 132 may prompt the user to name the user's favorite song. Authentication circuit 132 may record the user's reactions (e.g., brainwave electromagnetic field fluctuations) while the user is thinking of their favorite song and may save the reaction as the user's response. Additionally, or alternatively, authentication circuit 132 may play the user's favorite song and record the user's reactions when hearing the song. A user may perform the training process in a secure location to prevent unauthorized observation (e.g., listening or viewing) to the training process.

The training process may result in AI assistant 130 building a context-driven database for storing emotional reactions to certain stimulus, to later use during the authentication side when authentication circuit 132 authenticates the user. During the AI training process, authentication circuit 132 may populate an authentication database using voice interaction with the user. After the training process, EEG readings may be gradually used instead of, or in addition to, user voice input with the same authentication database. Authentication circuit 132 may be pre-configured to manage the authentication database. For example, authentication circuit 132 may be pre-configured with a storage location of the user data and the file format.

In some examples, the authentication process may be dynamic such that authentication circuit 132 may trigger a different stimulation for different authentications. Additionally, authentication circuit 132 may update the user's reactions based on the user's new experiences. AI assistant circuit 134 may observe the user and observe the user's brainwave electromagnetic field fluctuations when the user is presented with various stimulations. Authentication circuit 132 may track the user's new experiences (e.g., by using history threads) and automatically detect up-to-date user preferences to later use for stimulation. For example, if the user's favorite song changes, authentication circuit 132 may predict a different reaction when playing a previous favorite song compared to the predicted response when the song was the user's current favorite song.

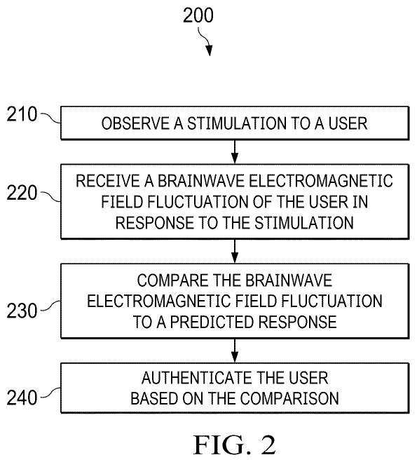

FIG. 2 illustrates a method for brainwave electromagnetic field fluctuation-based authentication, according to examples of the present disclosure. Method 200 may be implemented using a system, such as system 100 shown in FIG. 1, in combination with a processor, or any other system operable to implement method 200. Although examples have been described above, other variations and examples may be made from this disclosure without departing from the spirit and scope of these disclosed examples.

Method 200 may begin at block 210 by observing a stimulation provided to a user. A stimulation circuit may provide a stimulation for one or more of a user's senses (e.g., using an audio sound or displaying an image) to trigger an emotional response from the user. An authentication circuit may observe the stimulation provided by the stimulation circuit. In some examples, the system may not directly provide the stimulation and may instead, or in addition to directly providing the stimulation, observe the same real-time environmental data as the user (e.g., listen to the same song on the radio). The real-time environmental data may be used as the stimulation to trigger an emotional response from the user. In other words, the stimulation may be provided to the user by the environment.

At block 220, the system may receive a brain wave electromagnetic field fluctuation of the user in response to the stimulation (provided at block 210). An EEG node may capture brainwave electromagnetic field fluctuations and send encrypted data reflecting the fluctuations to an authentication circuit. Specifically, an electrode of the EEG node may capture brainwave electromagnetic field fluctuations, convert the analog signals to digital signals, and provide the digital signals to a controller. A transceiver at the EEG node may transmit the signals to the authentication circuit. In some examples, the received data reflecting a brainwave electromagnetic field fluctuation may be encrypted and the authentication circuit may decrypt the data before proceeding to block 230.

At block 230, the system may compare the brainwave electromagnetic field fluctuation to a predicted response. The authentication circuit may compare the data against a machine learning-based prediction of how the user may react to the provided stimulation. If the data matches, within predetermined parameters, the predicted reaction, the system may authenticate the user at block 240. After a successful authentication, the user may interact with the system. For example, the user may begin teaching the system, update the system, or share sensitive data with the system. If the data does not match the predicted reaction, the system may not authenticate the user and may deny access to the system to the user. In some examples, the system may repeat the authentication process multiple times. Repeated authentication may be used in circumstances where an increased level of security is desired.

Although FIG. 2 discloses a particular number of operations related to method 200, method 200 may be executed with greater or fewer operations than those depicted in FIG. 2. In addition, although FIG. 2 discloses a certain order of operations to be taken with respect to method 200, the operations comprising method 200 may be completed in any suitable order.

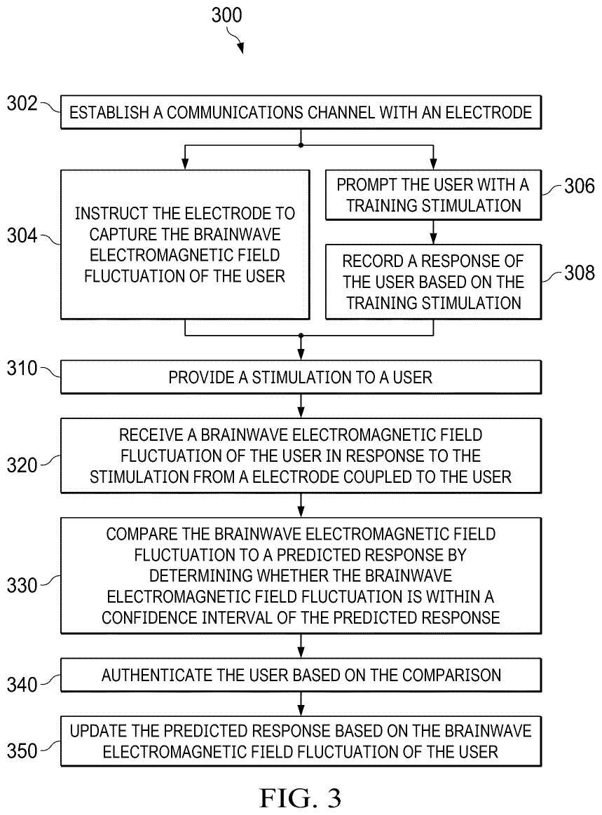

FIG. 3 illustrates a more detailed method for brainwave electromagnetic field fluctuation-based authentication, according to examples of the present disclosure. Method 300 may be implemented using a system, such as system 100 shown in FIG. 1, in combination with a processor, or any other system operable to implement method 300. Although examples have been described above, other variations and examples may be made from this disclosure without departing from the spirit and scope of these disclosed examples.

Method 300 may begin at block 302 where the system may establish a secure communications channel with an electrode coupled to a user. The secure communications channel may be any suitable communication protocol, such as a body-based communications channel, wired communications channel, or wireless communications channel, including, but not limited to, BODYCOM™, radio frequency (RF) (e.g., Bluetooth), audio waves, infrared, or wired (e.g., USB, Ethernet) transmission techniques. In some examples, a pre-configured encrypted communication channel may occur using a one-way communication channel from the EEG node to an authentication circuit in an AI assistant. The one-way communication channel may be used in examples where an asymmetric encryption configuration has already been provided by an equipment manufacturer.

At block 304, the system may instruct the electrode to capture a brainwave electromagnetic field fluctuation of the user.

At block 306, the system may prompt the user with a training stimulation. Block 306 may be performed during the initial setup of the system or when the user wishes to retrain the system. The training process may assist the authentication circuit with learning the user's reactions to stimulation. During the training process, the authentication circuit may record personal information about the user via audio communication, visual communication, or any combination thereof. The authentication circuit may then prompt the user with training stimulus based on the recorded personal information and begin correlating the information in the prompts with EEG readings (e.g., brainwave electromagnetic field fluctuations) and recording the responses for use during the authentication process. The training stimulation may be presented in any suitable format, such as, but not limited to, audio or visual formats. For example, the system may prompt the user to name the user's favorite song or may play a song or display an image.

At block 308, the system may record the user's reactions while the user is responding to the training stimulation provided at block 306. For example, the system may record the user's reactions when thinking of a song, hearing a song, or viewing an image. A user may perform the training process (blocks 304 and 306) in a secure location to prevent unauthorized observation (e.g., listening) to the training process.

At block 310, the system may provide a stimulation to a user. A stimulation circuit may provide a stimulation for one or more of a user's senses (e.g., using an audio sound or displaying an image) to trigger an emotional response from the user. For example, the system may play a portion of the user's favorite song. In some examples, the system may not directly provide the stimulation and may instead, or in addition to directly providing the stimulation, observe the same real-time environmental data as the user (e.g., listen to the same song on the radio). The real-time environmental data may be used as the stimulation to trigger an emotional response from the user. In some examples, method 300 may be dynamic. The system may provide a different stimulation for different instances of method 300. An authentication circuit may observe the stimulation provided by the stimulation circuit.

At block 320, the system may receive a brain wave electromagnetic field fluctuation of the user in response to the stimulation (provided at block 310). An EEG node may capture brainwave electromagnetic field fluctuations and send encrypted data reflecting the fluctuations to an authentication circuit. Specifically, an electrode of the EEG node may capture brainwave electromagnetic field fluctuations, convert the analog signals to digital signals, and provide the digital signals to a controller. The controller may process the digital signals for communication to an AI assistant communication interface or an AI assistant. A transceiver at the EEG node may transmit the signals to the authentication circuit. In some examples, the received data reflecting a brainwave electromagnetic field fluctuation may be encrypted and the authentication circuit may decrypt the data before proceeding to block 330.

At block 330, the system may compare the brainwave electromagnetic field fluctuation to a predicted response. The authentication circuit may compare the data against a machine learning-based prediction of how the user may react to the provided stimulation. If the data matches the predicted reaction, the system may authenticate the user at block 340. After a successful authentication, the user may interact with the system. For example, the user may begin teaching the system, update the system, or share sensitive data with the system. In some examples, the system may use a confidence interval to determine whether the data matches the predicted reaction. For example, if the system has greater than 80% confidence that the data matches the predicted reaction, the system may authenticate the user. The confidence interval may be set by the user. In some examples, the system may repeat the authentication process multiple times. Repeated authentication may be used in circumstances where an increased level of security is desired. In some examples, method 300 may be used in conjunction with other authentication methods, such as, but not limited to, a biometric scan, password, wearable security, or a head movement pattern token.

If the data does not match the predicted reaction, the system may not authenticate the user and may deny access to the system to the user. In some examples, the system may apply an ethical filter to the authentication process. For example, the system may not authenticate a user if the brainwave electromagnetic field fluctuations indicate that the user is exhibiting extreme anger or distress. In such circumstances, the user's logic may be impaired, and the system may deny the user access to the system and any sensitive data saved in the system. Additionally, the system may provide tools to assist the user in coping with anger or distress.

At block 350, the system may update the predicted response based on the brainwave electromagnetic field fluctuations of the user. For example, over time, the user may have a different reaction to hearing or thinking of the song than the user's reaction when the system was first trained (at blocks 306 and 308). The system may update the predicted response based on changes in the user's reaction to stimulations.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

Although examples have been described above, other variations and examples may be made from this disclosure without departing from the spirit and scope of these disclosed examples.

1. An apparatus, comprising:
an authentication circuit to:
observe a stimulation provided to a user;
receive a brainwave electromagnetic field fluctuation of the user in response to the stimulation;
compare the brainwave electromagnetic field fluctuation to a predicted response; and
authenticate the user based on the comparison.

2. The apparatus of claim 1, wherein the authentication circuit is to:
establish a communications channel with an electrode; and
instruct the electrode to capture the brainwave electromagnetic field fluctuation of the user.

3. The apparatus of claim 2, wherein the communications channel is a body-based communications channel, a wired communications channel, or a wireless communications channel.

4. The apparatus of claim 1, wherein the authentication circuit is to receive the brainwave electromagnetic field fluctuation of the user in response to the stimulation from an electrode coupled to the user.

5. The apparatus of claim 1, wherein comparison of the brainwave electromagnetic field fluctuation to the predicted response includes a determination of whether the brainwave electromagnetic field fluctuation is within a confidence interval of the predicted response.

6. The apparatus of claim 1, wherein the authentication circuit is to:
prompt the user with a training stimulation; and
record a response of the user based on the training stimulation.

7. The apparatus of claim 1, wherein the authentication circuit is to update the predicted response based on the brainwave electromagnetic field fluctuation of the user.

8. The apparatus of claim 1, comprising a stimulation circuit to provide the stimulation to the user.

9. A method, comprising:
providing a stimulation to a user;
receiving a brainwave electromagnetic field fluctuation of the user in response to the stimulation;
comparing the brainwave electromagnetic field fluctuation to a predicted response; and
authenticating the user based on the comparison.

10. The method of claim 9, comprising:
establishing a communications channel with an electrode; and
instructing the electrode to capture the brainwave electromagnetic field fluctuation of the user.

11. The method of claim 9, comprising receiving the brainwave electromagnetic field fluctuation of the user in response to the stimulation from a plurality of electrodes coupled to the user.

12. The method of claim 9, wherein comparison of the brainwave electromagnetic field fluctuation to the predicted response includes a determination of whether the brainwave electromagnetic field fluctuation is within a confidence interval of the predicted response.

13. The method of claim 9, comprising:
prompting the user with a training stimulation; and
recording a response of the user based on the training stimulation.

14. The method of claim 9, comprising updating the predicted response based on the brainwave electromagnetic field fluctuation of the user.

15. A system, comprising:
an electrode to capture a brainwave electromagnetic field fluctuation of a user;
an artificial intelligence (AI) assistant communication interface coupled to the electrode to provide a stimulation to the user; and
an AI assistant coupled to the electrode and the AI assistant communication interface, the AI assistant to:
receive the brainwave electromagnetic field fluctuation of the user in response to the stimulation;
compare the brainwave electromagnetic field fluctuation to a predicted response; and
authenticate the user based on the comparison.

16. The system of claim 15, wherein the AI assistant is to:
establish a communications channel with the electrode; and
instruct the electrode to capture the brainwave electromagnetic field fluctuation of the user.

17. The system of claim 15, wherein the AI assistant is to receive the brainwave electromagnetic field fluctuation of the user in response to the stimulation from a plurality of electrodes coupled to the user.

18. The system of claim 15, wherein comparison of the brainwave electromagnetic field fluctuation to the predicted response includes a determination of whether the brainwave electromagnetic field fluctuation is within a confidence interval of the predicted response.

19. The system of claim 15, wherein the AI assistant is to:
prompt the user with a training stimulation; and
record a response of the user based on the training stimulation.

20. The system of claim 15, wherein the AI assistant is to update the predicted response based on the brainwave electromagnetic field fluctuation of the user.
